(19) United States
(12) Patent Application Publication
(10) Pub. No.: US 2022/0375738 A1
(43) Pub. Date: Nov. 24, 2022

(54) METHODS, MEDIUMS, AND SYSTEMS FOR PROVIDING ASSISTED CALIBRATION FOR A MASS SPECTROMETRY APPARATUS

(71) Applicant: Waters Technologies Ireland Limited, Dublin 2 (IE)

(72) Inventors: Jonathan De Montfort, Wilmslow (GB); Andrew Berney, Widnes (GB)

(73) Assignee: Waters Technologies Ireland Limited, Dublin 2 (IE)

(21) Appl. No.: 17/749,449

(22) Filed: May 20, 2022

Related U.S. Application Data
(60) Provisional application No. 63/191,601, filed on May 21, 2021.

(51) Int. Cl. H01J 49/00; G01N 27/623

(52) U.S. Cl. CPC H01J 49/0036; H01J 49/0009; G01N 27/623; H01J 49/0031

(57) ABSTRACT

Exemplary embodiments relate to the calibration of mass spectrometry data, and may be especially useful for calibrating collision cross sectional data. These techniques apply assisted (rather than automated) calibration techniques. Context-sensitive user interfaces are presented that allow a user to review matches made by a calibration algorithm, and to override prior selections to improve the fit of a model used to make a calibrating adjustment. The calibrating adjustment can then be applied to past or future data coming from the device in order to normalize it and allow it to be compared to other data.

### CROSS-REFERENCE TO RELATED APPLICATIONS

This application claims the benefit of and priority to U.S. Provisional Patent Application No. 63/191,601, filed on May 21, 2021, the entire contents of which are incorporated by reference.

### BACKGROUND

Mass spectrometry (MS) devices are used to measure a mass-to-charge (m/z) ratio of molecules in a sample. When analyzing a sample, a number of factors can contribute to variability in the results; these factors might include the age or condition of the MS device, settings on the MS device, the conditions in the laboratory when the sample was run, the skill or preferences of the user of the device, etc. In order to generate reproducible results, a sample of a known reference compound may be analyzed by the device and used to generate a set of sample results. The sample results may then be compared against the standard results for that sample and used to generate a calibration factor used to adjust or scale the data. The calibration factor may be applied to future data coming from the MS device to allow the data to be harmonized with other data coming from the same MS device at a different time, or from other MS devices.

Generating the calibration factor from the sample results can be a complex task. Because the reference used to generate the sample is a known entity, the expected set of mass peaks from the sample is known; for example, a library of mass spectra from known reference compounds might be maintained. However, these known mass peaks (referred to herein as the “reference” peaks) must be matched to the peaks actually observed when the sample was analyzed. In some cases, peaks may be missing from the real-world sample data. In others, multiple peaks may be generated in close proximity to each other, and it may be difficult to distinguish which peak corresponds to a given reference peak. Still further, noise can result in an apparent peak generated at a place where one should not exist (although it might be mistaken for a reference peak, if it is of sufficient intensity and close enough to where the reference peak should be). Note that the above applies to mass calibration; collision cross section (CCS) calibration may be somewhat more complex due to the need to account for the complex motion of particles through the drift tube.

Conventional systems may apply automatic calibration techniques, whereby peaks in the reference data are compared to peaks in the sample data. Unfortunately, many automatic calibration techniques take a simplistic approach to matching the peaks (typically matching a reference peak to the most intense nearby peak from the sample data). Although such techniques can produce reasonable results, they can also mismatch reference peaks to incorrect sample peaks, reducing the effectiveness of the calibration factor.

### BRIEF SUMMARY

Exemplary embodiments relate to methods, mediums, and systems for performing an assisted calibration of MS data. Unless otherwise noted, it is contemplated that the embodiments described below may be employed separately to achieve the benefits noted or may be employed in any combination in order to achieve further synergistic effects.

According to a first embodiment, an analysis of a sample compound may be received from a mass spectrometry (MS) apparatus. The analysis may be associated with a plurality of mass peaks. A set of mass peaks of a reference compound may also be received. A subset of the mass peaks of the sample compound may be mapped to a corresponding subset of peaks of the reference compound. This mapping may initially be performed automatically and may include matching at least a first peak of the reference compound to a first peak of the sample compound. The mapping may be overridden, which may involve (among other options) matching the first peak of the reference compound to a second peak of the sample compound (different from the first peak of the sample compound), or matching the first peak of the reference compound to no peak in the sample compound. The mapping may be used to define a calibrating adjustment that can be applied to future data received from the MS apparatus.

Because the mapping can be overridden to remove a peak pairing or to replace a peak pairing, erroneous matchings can be reduced or eliminated. This improves a fit of a model used to define the calibrating adjustment, which results in a more accurate calibration. Because the first pass through the mappings can be done in an automated manner, much time can be saved over a (theoretical) entirely manual mapping process, which is difficult and time-consuming to perform, and error-prone.

For example, if the automatic calibration matches a reference peak to a sample peak, and it is later realized that the sample peak is actually two overlapping peaks, it might be preferable not to use the matching because the precise bounds of the sample peak cannot be ascertained.

According to a second embodiment, the MS apparatus may be an ion mobility mass spectrometry apparatus. According to a third embodiment, the reference compound may be a custom reference compound received from a user. Assisted peak-matching has been found to better distinguish between cases that might be difficult for an automatic calibration algorithm, such as when custom reference compounds are used, when CCS is employed, and in IMS devices where the effective drift tube length is more than about 20 cm (especially when the drift tube allows the ions to travel in a cyclic pattern).

According to a fourth embodiment, the corresponding subset of peaks of the reference compound may be displayed in a reference compound interface on a display. A selection of the first peak of the reference compound may be received, and a plurality of peaks of the sample compound that fall within a predefined window of masses around the first peak of the reference compound may be displayed in a sample compound interface on the display. The plurality of peaks may include the first peak of the sample compound and the second peak of the sample compound.

The fourth embodiment provides a context-sensitive display of the peaks in the sample compound that could reasonably be mapped to the peak in the reference compound. If no such peaks exist, none will be displayed. If only one peak from the sample compound is relevant, then only the relevant peak will be displayed. This simplifies the decision-making at this point: should the peak be included in the calibration or not? If multiple peaks are available, a user can decide to override the automatic calibration algorithm's decision making and map the reference peak to a desired sample peak. This may potentially involve replacing the peak selected by the automatic calibration algorithm. Because the display is context-sensitive, only the relevant information (sample peaks within the window) is shown to the user, which makes it easier to decide which peaks to consider.

According to a fifth embodiment used in conjunction with the fourth embodiment, overriding the mapping may include receiving a selection of the second peak of the sample compound in the sample compound interface. Because the display is context-sensitive, an eligible second peak will be displayed in the sample compound interface, providing a simple way to select the second peak to override the initial assignment of the first sample peak to the reference peak.

According to a sixth embodiment, for each of the mass peaks of the sample compound mapped to corresponding peaks of the reference compound, a residual value may be calculated based on a closeness of a match between each mapped pair of peaks. The residual values may be displayed in a residual interface on the display. A selection of one of the residual values may be received, where the selected residual value corresponds to a pair of matched peaks from the reference compound and the sample compound. The mapping between the pair of matched peaks may be removed, and the calibrating adjustment may be recalculated.

According to a seventh embodiment, the calibrating adjustment may be based on a plurality of points fitted with a regression line. The plurality of points and the regression line may be displayed in a model fit interface on the display. A selection of one of the points may be received, where the selected point corresponds to a pair of matched peaks from the reference compound and the sample compound. The mapping between the pair of matched peaks may be removed, and the calibrating adjustment may be recalculated with the selected point removed from the plurality of points.

The sixth and seventh embodiments allow a peak matching selected by the automatic calibration (or a matching made later, through assisted calibration) to be removed from consideration (or replaced with different matches) for purposes of the calibrating adjustment. The sixth and seventh embodiments provide additional entry points into the system that might be helpful to the user and not readily accessible from an interface that only shows the matched peaks. In the sixth embodiment, the user can see how each peak matching influences the model used to define the calibrating adjustment, and whether some peaks are outliers. It might be the case that removing certain peaks, even though they match within an acceptable tolerance, could simplify or improve the model fit. In the seventh embodiment, the user can see how well the reference peak matches up to the sample peak (e.g., after the calibrating adjustment has been applied). If the residual value indicates that the match is not ideal, this will be readily apparent in the seventh embodiment and a user can easily take action to remove or replace the mapping to improve the residual value.

An action such as this (or any of the others described herein) may be logged in an audit trail, so that future reviewers can determine how the calibrating adjustment was arrived at and whether decisions were made to achieve a desired, rather than scientifically justified, outcome.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a mass spectrometry (MS) system according to an exemplary embodiment.

FIG. 2A depicts an exemplary user interface for setting up an MS experiment in accordance with one embodiment.

FIG. 2B depicts an exemplary user interface for setting up an MS experiment in accordance with one embodiment.

FIG. 3 depicts an exemplary user interface for setting up an MS experiment in accordance with one embodiment.

FIG. 4 depicts an exemplary user interface for setting up an MS experiment in accordance with one embodiment.

FIG. 5A depicts an exemplary user interface for setting up an MS experiment in accordance with one embodiment.

FIG. 5B depicts an exemplary user interface for setting up an MS experiment in accordance with another embodiment.

FIG. 6A depicts an exemplary user interface for setting up an MS experiment in accordance with one embodiment.

FIG. 6B depicts an exemplary user interface for setting up an MS experiment in accordance with one embodiment.

FIG. 7 depicts an exemplary user interface for performing assisted calibration in accordance with one embodiment.

FIG. 8A depicts an exemplary user interface for performing assisted calibration in accordance with one embodiment.

FIG. 8B depicts an exemplary user interface for performing assisted calibration in accordance with one embodiment.

FIG. 9A depicts an exemplary user interface for performing assisted calibration in accordance with one embodiment.

FIG. 9B depicts an exemplary user interface for performing assisted calibration in accordance with one embodiment.

FIG. 9C depicts an exemplary user interface for performing assisted calibration in accordance with one embodiment.

FIG. 9D depicts an exemplary user interface for performing assisted calibration in accordance with one embodiment.

FIG. 10 is a flowchart depicting logic for performing a method according to an exemplary embodiment.

FIG. 11 depicts an illustrative computer system architecture that may be used to practice exemplary embodiments described herein.

### DETAILED DESCRIPTION

One reason that automatic calibration systems involving collisional cross section (CCS) data can have difficulty in matching sample data to reference data is that some MS devices acquire data, such as ion mobility spectrometry (IMS) data, in an iterative fashion. In traditional IMS, molecules are passed through a linear drift tube filled with a drift gas. Some molecules will travel faster than others, depending on their charge, mass, size, and chemical structure. This combination of factors defines a CCS of a molecule, which provides an additional dimension of resolution as compared to the more straightforward m/z analysis.

In IMS, a longer drift tube allows for more separation between different types of molecules in the sample. The effects of a longer drift tube can be approximated by making the drift tube into, e.g., a circular, ring, tortuous path, folded, reflecting, or mobius shape that may permit passing the molecules around multiple times (see, e.g., the SELECT SERIES CYCLIC IMS by WATERS CORPORATION of Milford, Mass., the SLIM-based ion mobility product by MOBILion Systems). As the molecules are selectively ejected to a detector, a peak may be generated in corresponding data. Peaks will be generated for each molecule, and because the effective travel length of the molecules is longer than it would be for a traditional linear drift tube, the mass peaks will become more and more separated (as faster molecules separate from slower molecules to a greater degree over the greater distance due to their CCS).

However, when analyzing the data resulting from such an IMS device for calibration purposes, it can be difficult for an automatic calibration algorithm to determine where each cycle begins and ends. For example, a relatively fast molecule might travel through the drift tube twice before a relatively slow molecule completes a first pass, complicating the calculation of the molecules' drift time. In one example, if the relatively fast molecule is able to “catch up” to the relatively slow molecule in a subsequent pass, it might be difficult to distinguish where the fast molecule's peak ends and the slow molecule's peak begins.

This issue is compounded by the fact that particular users might wish to use custom reference compounds. There are a number of commonly-used reference compounds that perform well for device calibration. Especially when used with sampling methods having larger effective path lengths, it can be important to select compounds whose constituent components will be easily distinguished over a reasonable number of iterations. Nonetheless, for a variety of reasons a user might wish to use their own reference compound. The peaks in these compounds might not be well-distinguished when analyzed with an MS device having a drift tube with a large effective path length, making it more difficult for automatic calibration to identify the molecules' peaks.

In order to address these problems, exemplary embodiments described herein apply assisted (rather than automated) calibration techniques. Context-sensitive user interfaces are presented that allow a user to review matches made by a calibration algorithm, and to override prior selections to improve the fit of a model used to make a calibrating adjustment. The calibrating adjustment can then be applied to future data coming from the device in order to normalize it and allow it to be compared to other data.

With the techniques described herein, users can improve instrument calibration processes, overriding an automated peak match in certain problematic conditions. For instance, when a custom reference compound is used, a user having experience with the compound may be able to identify when the automated algorithm has mismatched a reference peak to a sample peak. If a match was made within the calibration algorithm's tolerance, but only barely, a user can switch the matched peak to a different peak (or to no peak, removing the reference peak from consideration). This may improve the model fit. Several different ways are provided for a user to re-match or un-match peaks, based on the context of sample peaks that are within a certain window of the reference peak, how well a peak match fits with the model used to make the calibrating adjustment, or a residual value indicating a closeness of a match between a pair of mapped peaks (e.g., after the calibrating adjustment is applied).

Exemplary embodiments have been found to work especially well in an IMS device having a drift tube of length greater than 20 cm. This may be a linear drift tube having a length greater than 20 cm, or a drift tube whose effective length is greater than 20 cm. For example, the arrangements described above. Especially when the acquisition technique is iterative, over these distances molecules can begin to overlap each other. This confuses the calibration algorithm as to which reference peak a given sample peak belongs to (and potentially causing some sample peaks to overlap).

It is noted that, although exemplary embodiments may be particularly well-suited to use in CCS devices, especially IMS devices and iterative IMS devices, the present invention is not limited to these use cases. Any type of MS calibration data can be imperfect or noisy, or be difficult to align programmatically to a reference data set, and the techniques described herein may be used to improve the calibration of MS data whether applied to m/z analyses, CCS analyses, IMS techniques, iterative devices, non-cyclic devices, etc.

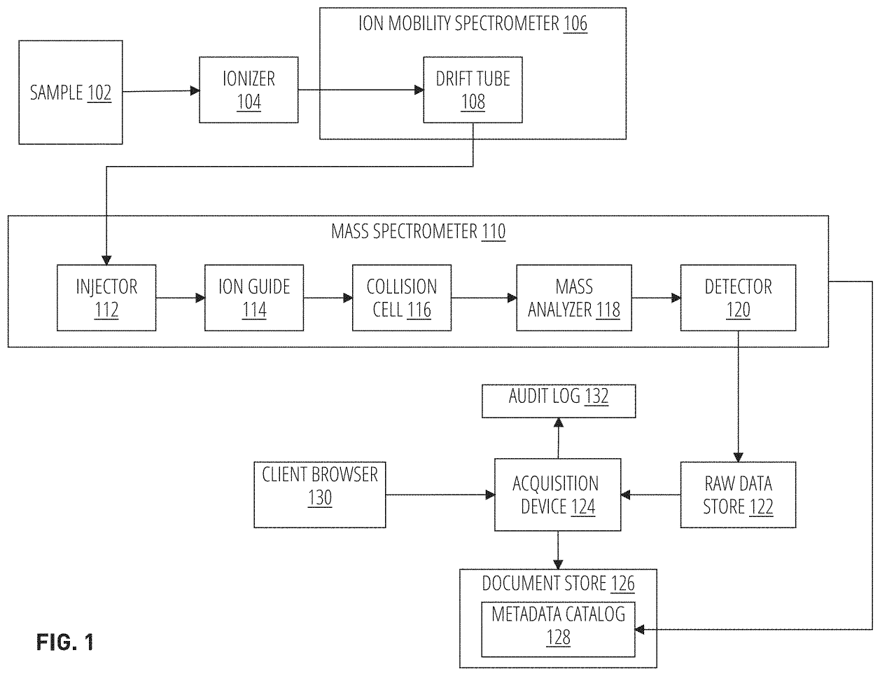

For purposes of illustration, FIG. 1 is a schematic diagram of a system that may be used in connection with techniques herein. Although FIG. 1 depicts particular types of devices in a specific IMS-MS configuration, one of ordinary skill in the art will understand that different types of chromatographic devices (e.g., MS, LC-MS, tandem MS, etc.) may also be used in connection with the present disclosure.

A sample 102 is injected into an ionizer 104 where it is converted into gas phase ions. For example, samples may be ionized using thermal desorption, radioactive ionization, corona discharge ionization, photoionization, or any other suitable techniques.

The ionized sample may then be introduced into an ion mobility spectrometer 106. The ion mobility spectrometer 106 may include a drift tube 108 filled with a drift gas. The drift gas moves from the end of the drift tube 108 (the point at which the drift gas is introduced) towards the beginning of the drift tube 108, while the ions of the sample are encouraged to move from the beginning of the drift tube 108 (the point at which they are introduced) towards the end of the drift tube 108. The drift tube 108 may include focusing rings configured to generate an electric field gradient in the drift tube 108, which encourages the sample ions to move towards the end of the drift tube 108. A drift tube 108 may be, for example, 5 cm-300 cm in length. Exemplary embodiments may be particularly advantageous when used in connection with a drift tube of 20 cm or more in effective length.

As the ions move through the drift tube 108, their interactions with the draft gas causes some of the ions to pass through the drift tube 108 more quickly than others. In conventional MS, the speed at which a molecule moves through the MS apparatus may depend on its mass and charge; when IMS is used, the molecules' speed can also be affected by the molecule's size and shape—for example, a molecule having a more open three-dimensional structure will not move through the drift gas at the same speed as a molecule of similar weight but having a more closed three-dimensional structure. Accordingly, the ion mobility spectrometer 106 is able to analyze molecules' collision cross sections (CCS). Especially when coupled with MS analysis, CCS analysis provides a greater degree of resolution than MS alone.

The output from the ion mobility spectrometer 106 is input to a mass spectrometer 110 for analysis. Initially, the sample is desolved and ionized by a desolvation/ionization device 112 (note that ionization may not be necessary if the mass spectrometer 110 receives an ionized input, as it might when coupled to an ion mobility spectrometer 106). Desolvation can be any technique for desolvation, including, for example, a heater, a gas, a heater in combination with a gas or other desolvation technique. Ionization can be by any ionization techniques, including for example, electrospray ionization (ESI), atmospheric pressure chemical ionization (APCI), matrix assisted laser desorption (MALDI) or other ionization technique. Ions resulting from the ionization are fed to a collision cell 116 by a voltage gradient being applied to an ion guide 114. Collision cell 116 can be used to pass the ions (low-energy) or to fragment the ions (high-energy).

Different techniques (including one described in U.S. Pat. No. 6,717,128, to Bateman et al., which is incorporated by reference herein) may be used in which an alternating voltage can be applied across the collision cell 116 to cause fragmentation. Spectra are collected for the precursors at low-energy (no collisions) and fragments at high-energy (results of collisions).

The output of collision cell 116 is input to a mass analyzer 118. Mass analyzer 118 can be any mass analyzer, including quadrupole, time-of-flight (TOF), ion trap, magnetic sector mass analyzers as well as combinations thereof. A detector 120 detects ions emanating from mass analyzer 120. Detector 120 can be integral with mass analyzer 118. For example, in the case of a TOF mass analyzer, detector 120 can be a microchannel plate detector that counts intensity of ions, i.e., counts numbers of ions impinging it.

A raw data store 122 may provide permanent storage for storing the ion counts for analysis. For example, raw data store 122 can be an internal or external computer data storage device such as a disk, flash-based storage, and the like. An acquisition device 124 analyzes the stored data. Data can also be analyzed in real time without requiring storage in a storage medium 122. In real time analysis, detector 120 passes data to be analyzed directly to computer 124 without first storing it to permanent storage.

Collision cell 116 performs fragmentation of the precursor ions. Fragmentation can be used to determine the primary sequence of a peptide and subsequently lead to the identity of the originating protein. Collision cell 116 includes a gas such as helium, argon, nitrogen, air, or methane. When a charged precursor interacts with gas atoms, the resulting collisions can fragment the precursor by breaking it up into resulting fragment ions. Such fragmentation can be accomplished as using techniques described in Bateman by switching the voltage in a collision cell between a low voltage state (e.g., low energy, <5 V) which obtains MS spectra of the peptide precursor, with a high voltage state (e.g., high or elevated energy, >15V) which obtains MS spectra of the collisionally induced fragments of the precursors. High and low voltage may be referred to as high and low energy, since a high or low voltage respectively is used to impart kinetic energy to an ion.

Various protocols can be used to determine when and how to switch the voltage for such an MS/MS acquisition. For example, conventional methods trigger the voltage in either a targeted or data dependent mode (data-dependent analysis, DDA). These methods also include a coupled, gas-phase isolation (or pre-selection) of the targeted precursor. The low-energy spectra are obtained and examined by the software in real-time. When a desired mass reaches a specified intensity value in the low-energy spectrum, the voltage in the collision cell is switched to the high-energy state. The high-energy spectra are then obtained for the pre-selected precursor ion. These spectra contain fragments of the precursor peptide seen at low energy. After sufficient high-energy spectra are collected, the data acquisition reverts to low-energy in a continued search for precursor masses of suitable intensities for high-energy collisional analysis. Embodiments may also use techniques described in Bateman which may be characterized as a fragmentation protocol in which the voltage is switched in a simple alternating cycle.

The data acquired by the high-low protocol allows for the accurate determination of the retention times, mass-to-charge ratios, and intensities of all ions collected in both low- and high-energy modes. In general, different ions are seen in the two different modes, and the spectra acquired in each mode may then be further analyzed separately or in combination. The ions from a common precursor as seen in one or both modes will share the same retention times (and thus have substantially the same scan times) and peak shapes. The high-low protocol allows the meaningful comparison of different characteristics of the ions within a single mode and between modes. This comparison can then be used to group ions seen in both low-energy and high-energy spectra.

Metadata describing various parameters related to data acquisition may be generated alongside the raw data. This information may include a configuration of the ion mobility spectrometer 106 or mass spectrometer 110 (or other chromatography apparatus that acquires the data), which may define a data type. An identifier (e.g., a key) for a codec that is configured to decode the data may also be stored as part of the metadata and/or with the raw data. The metadata may be stored in a metadata catalog 128 in a document store 126.

The acquisition device 124 may operate according to a workflow, providing visualizations of data to an analyst at each of the workflow steps and allowing the analyst to generate output data by performing processing specific to the workflow step. The workflow may be generated and retrieved via a client browser 130. As the acquisition device 124 performs the steps of the workflow, it may read raw data from a stream of data located in the raw data store 122. As the acquisition device 124 performs the steps of the workflow, it may generate processed data that is stored in a metadata catalog 128 in a document store 126; alternatively or in addition, the processed data may be stored in a different location specified by a user of the acquisition device 124. It may also generate audit records that may be stored in an audit log 132. The audit log 132 may record each of the actions taken during data collection, calibration, and analysis, which may include logging the actions described below with reference to exemplary embodiments.

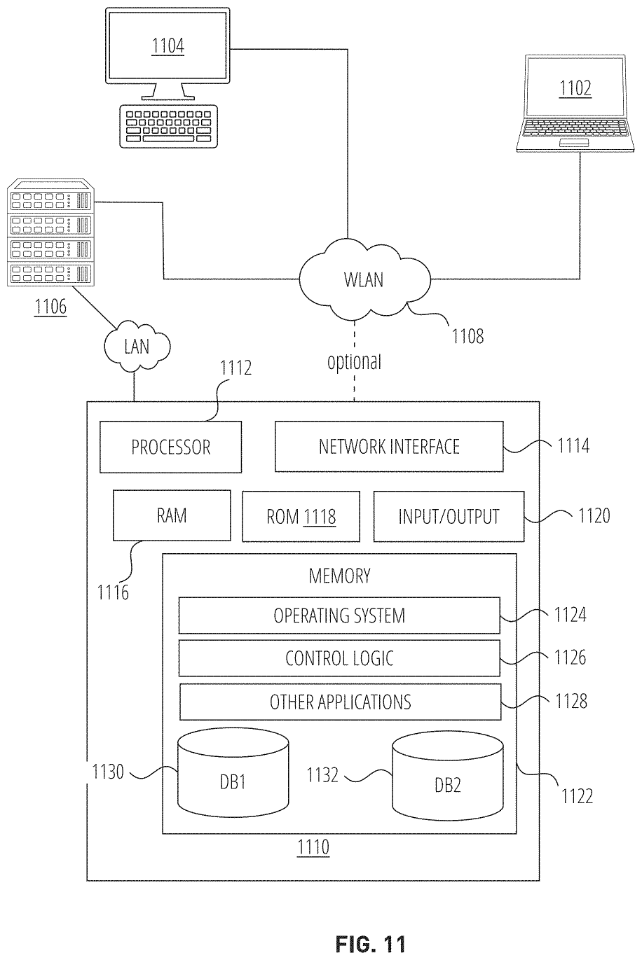

The exemplary embodiments described herein may be performed at the client browser 130 and acquisition device 124, among other locations. An example of a device suitable for use as an acquisition device 124 and/or client browser 130, as well as various data storage devices, is depicted in FIG. 11.

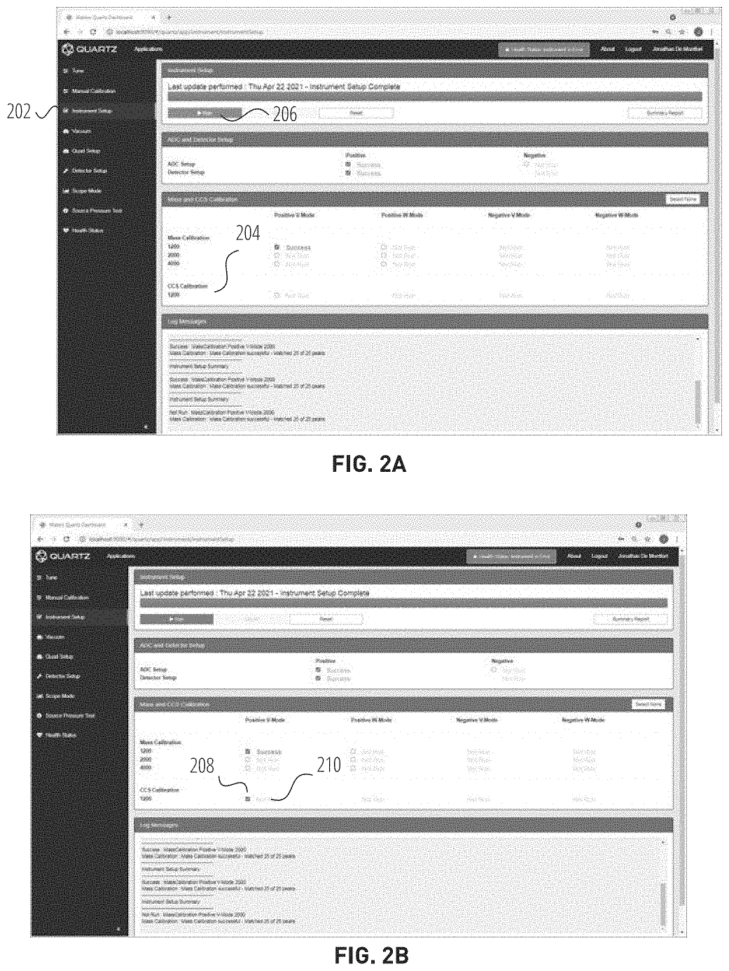

FIG. 2A depicts an exemplary interface for setting up an MS calibration experiment, wherein data will be acquired from an MS device for purposes of defining a calibrating adjustment to be applied to future data received from the device. In this view, an instrument setup element 202 has been selected in order to display the calibration setup interface on the right side of the screen. The calibration setup interface includes a CCS calibration setup element 204 that shows CCS slots available for calibration. An acquisition start element 206 allows a user to start acquiring data, once all the calibration settings are set up.

FIG. 2B shows the interface of FIG. 2A after a user has selected a CCS calibration setup element 204, indicating that the user wishes to use CCS in connection with the current experiment. To reflect the selection, a CCS calibration slot selector 208 is marked as checked. The current status of calibrating the IMS instrument that will be used to perform the CCS analysis is indicated in the CCS calibration status 210.

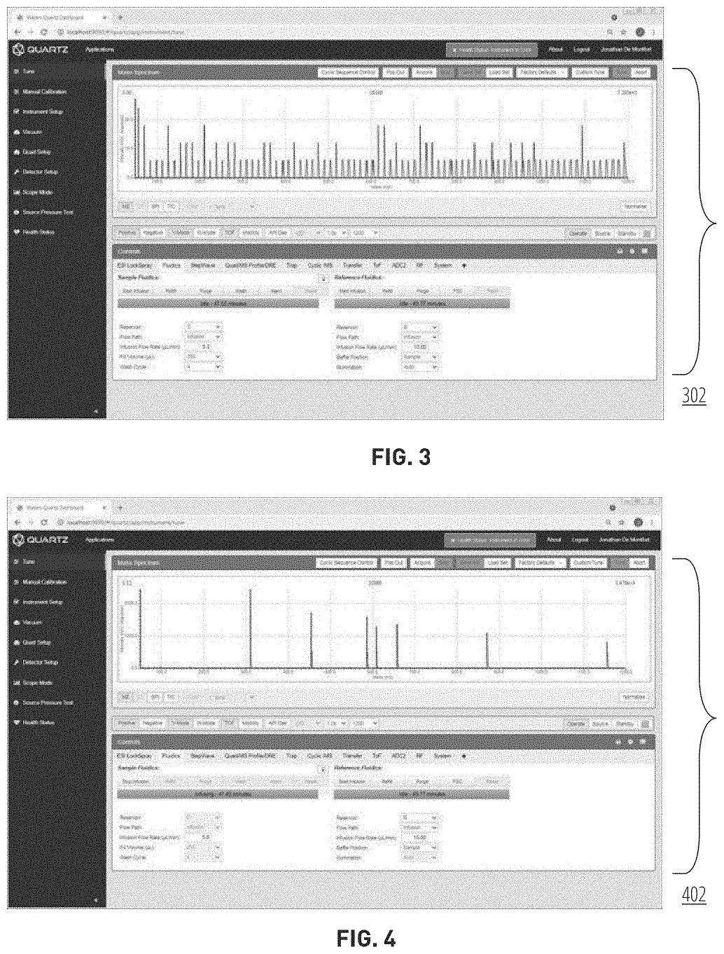

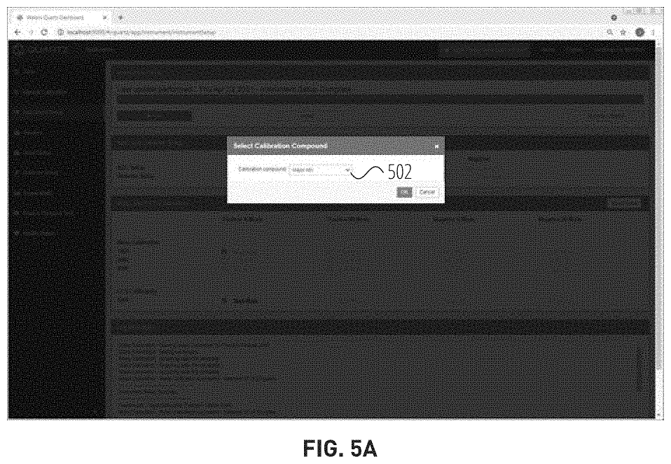

A user may next select a sample vial for testing, as shown on the sample vial interface 302 shown in FIG. 3. Next, a user may begin infusion of the sample using an infusion interface 402, an example of which is shown in FIG. 4.

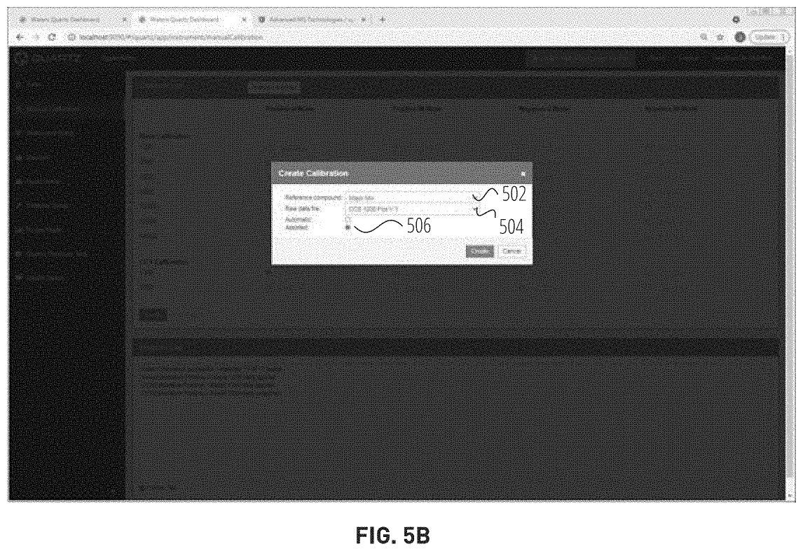

When the user then returns to the interface as shown in FIG. 2A, the user may select the acquisition start element 206, causing an interface such as the one shown in FIG. 5A to be displayed. This interface allows a user to inform the system what type of calibration (reference) compound is being analyzed. To this end, a reference compound dropdown menu 502 may be provided, including a number of options for commonly used reference compounds. The reference compound dropdown menu 502 may also provide an option to select a custom reference compound. Each reference compound may be associated with predefined reference mass peak data, which may be stored in a library (e.g., a library present on, or accessible to, the acquisition device 124). If a custom reference compound is used, a user may also provide the predefined reference mass peak data (e.g., by indicating a location from which such data can be retrieved or uploading the data directly).

An interface like the one shown in FIG. 5A may be useful when the acquisition of sample data is automated; it is also possible, however, to use manually-acquired sample data to define a calibrating adjustment factor. In that case, an interface like the one shown in FIG. 5B might be used. In this example, in addition to a reference compound dropdown menu 502, the interface may also include a raw data file input element 504 that allows the user to provide a location where manually-acquired sample data can be found. A calibration mode selector 506 allows a user to toggle between an automatic calibration mode (in which peaks are automatically matched without allowing for user intervention to override the decisions of the peak matching algorithm) or an assisted calibration mode (in which the system makes recommendations as to how to match peaks, but the user can make their own selections or override the peak matching algorithm).

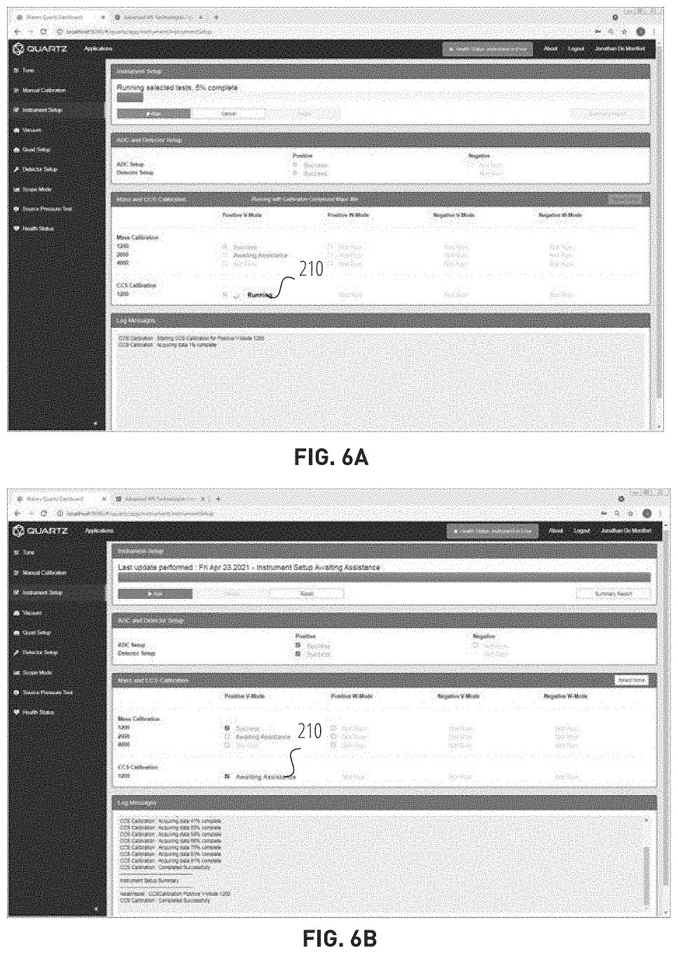

After an indication of the reference compound used in the data acquisition is provided, the user may be returned to the main interface, as shown in FIG. 6A. At this point, the CCS calibration status 210 is updated to reflect the fact that data acquisition for the sample is in progress.

When sample data acquisition is complete, the display may be updated. In this case, the user selected an assisted calibration mode, so the system applied an automatic peak matching algorithm to initially match mass peaks from the predefined reference mass peak data from the library with the peaks observed in the recently-acquired sample. The system now will allow the user to review and potentially override these initial matches, and so the CCS calibration status 210 is updated to reflect a status of “awaiting assistance.”

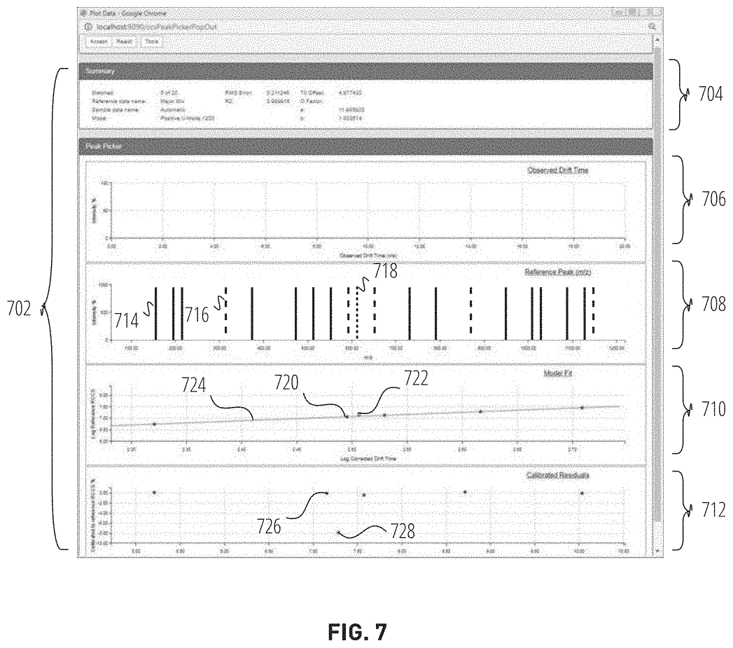

A user can select the CCS calibration status 210 to cause an assistance interface 702, such as the one depicted in FIG. 7, to be displayed. The assistance interface 702 presents the initial peak matchings made by an automated calibration algorithm and allows a user to override those matchings; in other embodiments, the assistance interface 702 might provide suggested mappings as determined by an automated calibration algorithm, but then might require the user to make a selection for each peak. Any peak not selected for matching would not be included in determining a calibrating adjustment. The assistance interface 702 may include a summary interface 704 showing various parameters relating to the reference compound and the calibrating adjustment (as currently configured) so that a user can see how changes to the peak matchings affects the calibration.

The automated calibration algorithm may work by comparing the relative locations of the mass peaks in the predefined reference mass peak data to the mass peaks observed in the sample. The amount of time required for a given molecule to arrive at a detector on the MS device depends, in part, on the molecule's mass-to-charge ratio and the number of iterations that a molecule may travel through in, e.g., iterative IMS drift tube. The predefined reference mass peak data may provide the known mass-to-charge ratios (m/z) for the known molecules present in the reference compound. These known m/z values may be used to determine an expected amount of time (the “drift time”) from when the reference compound is injected into the MS device until the molecule corresponding to the m/z value arrives at the detector. The automated calibration algorithm may define a window around the expected drift time based on a predefined threshold value. The size of the window may be selected so that any mass peak observed in the sample compound data that is observed within the window could reasonably (e.g., within a predefined threshold probability) be considered to be the molecule represented by the m/z in the predefined reference mass peak data. Typically, the strongest mass peak observed within the window will be considered to correspond to the m/z value from the reference compound data; accordingly, the peak within the window (if any) with the highest intensity may be initially selected by the automated calibration algorithm as an initial match for the reference compound data's mass peak.

The m/z values from the reference compound data may be displayed in a reference compound interface 708. Due to a variety of factors, it is unlikely that a single analysis of a real-world sample would include peaks corresponding to all the theoretical m/z values from the reference compound data. Accordingly, the m/z values in the reference compound interface 708 may be visually distinguished from each other (e.g., using different colors). The depicted example includes an unmatched peak 714 that is indicated by a solid line; an unmatched peak 714 may be a peak for which no corresponding mass peak was observed in the sample data within the acceptable window (or, at least, no peaks above a predetermined minimum threshold intensity).

The depicted example also includes a matched peak 716 that is indicated by a dashed line. A matched peak 716 represents a mass peak in the reference compound data that was successfully matched to a peak in the sample compound data. It is noted that there may be more than one peak in the sample compound data that is within the window corresponding to the reference compound m/z value. In this case, the reference compound interface 708 indicates that the peak has been matched (initially, to the highest intensity peak in the window).

The depicted example also includes a rejected peak 718 that is indicated by a dotted line. A rejected peak 718 represents a mass peak in the reference compound data that has at least one candidate peak within the window in the sample compound data, but all such candidate peaks have been rejected from matching. The rejection may be made by the automatic calibration algorithm. For example, no sample compound peaks within the window may rise above a predetermined minimum threshold value. Alternatively or in addition, after calculating the model fit with the peak matched, residual values may be calculated. The residual value may represent how closely the sample peak matches the expected reference peak (e.g., after the calibrating adjustment is applied). If the residual value associated with the matched peaks is below a predetermined minimum threshold value, or, equivalently, above a predetermined maximum threshold value, or outside a predetermined range, then the match may be rejected. Still further, the matching may be rejected by a user, as described below.

The assistance interface 702 includes a sample compound interface 706 that is context-sensitive. As shown in FIG. 7, when no selections have been made, the sample compound interface 706 may initially be empty. As users select peaks or points in the other portions of the assistance interface 702, the sample compound interface 706 may be updated to show peaks in the sample compound that are relevant to the current selections.

For example, if a user selects a matched peak 716 from the reference compound interface 708, one or more sample peaks within the window around the reference compound mass peak may be displayed in the sample compound interface 706. Because the selected peak was a matched peak 716, it must be matched to one of the sample compound peaks, and this peak to which it has been matched may be distinguished from the other peaks (e.g., displayed in a different color, bolded, displayed with a different pattern, etc.). If an unmatched peak 714 is selected, the sample compound interface 706 will remain blank—an unmatched peak 714 means that no corresponding peaks were found in the sample data, and so there are no peaks to show. If a rejected peak 718 is selected, then the sample compound interface 706 will be updated with one or more peaks that were present in the window, but none will be selected. If a peak is rejected in the reference compound interface 708, it means that at least one corresponding peak did exist, but it was rejected for one reason or another.

The sample compound interface 706 can be used to override the initial mappings. For example, if a matched peak 716 is selected and more than one corresponding sample peak is shown in the sample compound interface 706, then the peak to which the matched peak 716 has been mapped may be changed (e.g., by selecting a different peak). It is also possible to unmatch the peak so that the matched peak 716 maps to no peak in the sample compound interface 706; in this case, the display in the reference compound interface 708 may be updated so that the matched peak 716 becomes a rejected peak 718. If a rejected peak 718 is selected in the reference compound interface 708, then the available peaks within the window may be shown in the sample compound interface 706; the user can select one of these peaks, which would cause the rejected peak 718 to be updated to become a matched peak 716.

As peaks are matched and unmatched, they contribute to a model that attempts to adjust the sample data to better match the reference data. The model defines a calibrating adjustment, such as a scaling factor, that when applied to the sample data causes the sample data to approach the reference data. The peaks contributing to the model fit are displayed as points in a model fit interface 710. Each of the reference peaks may be reflected in the model fit interface 710, with those contributing to the model (i.e., those which have matched peaks in the sample data) visually distinguished from the peaks that do not contribute to the model (i.e., those which do not have matched peaks in the sample data). For instance, the model fit interface 710 shows an included model point 720 in one color, and an excluded model point 722 in another color.

A model fit 724 (e.g., a regression line) shows how closely the model matches the data; if the model fit 724 passes through or very close to all the included model points, this generally represents a model that is able to match the sample data to the reference data very well. In order to evaluate the model fit for each individual peak, a residual interface 712 may be displayed. The residual interface 712 shows a residual value calculated for each reference peak. If the model matches the sample peak to the reference peak precisely, the residual value may be zero. Otherwise, there will be some residual score (in this example, the score becomes more negative as the fit becomes poorer). In the initial pass by the automated calibration algorithm, a peak that is initially matched may be rejected if the resulting residual value is too low.

The residual interface 712 may include a number of points corresponding to the reference peaks. Points may be visually distinguished depending on whether they contribute to the model (i.e., are matched) or not (i.e., are rejected). For instance, the residual interface 712 depicted in FIG. 7 includes an included residual point 726 in one color, and an excluded residual point 728 in a different color.

In addition to being able to select reference peaks in the reference compound interface 708 for matching and unmatching, the model points and residual points are also selectable. The rest of the assistance interface 702 may be updated in response to a selection. For instance, if a user sees that a particular point in the model fit interface 710 has been included in the model but could be excluded to make the model fit 724 better, then the user can select that model point. The residual interface 712 will be updated to highlight the residual point associated with the selected point, and the sample compound interface 706 and reference compound interface 708 will also be updated. The reference compound interface 708 will be updated to highlight the matched reference peak that is associated with the selected model point, and the sample compound interface 706 will be updated to show at least the peak in the sample compound that was mapped to the highlighted reference peak (in some embodiments, all sample peaks within the reference peak's window may be displayed). The user could then match the reference peak to a different sample peak to see whether the model fit 724 improved, or unmatch the reference peak from any sample peaks so that the reference peak would no longer contribute to the model. A new calibrating adjustment would then be calculated, and the model fit interface 710 and residual interface 712 would be updated accordingly. This procedure allows a user to quickly improve a model fit by interacting directly with the points in the model fit interface 710. In a system without such capabilities, improving the model fit might involve a great deal of trial and error as the user tries to find which peak matching or matchings are affecting the model, and in which way.

The user can also interact directly with the residual interface 712. In some cases, a residual value may be low, but not low enough to cause the automated calibration algorithm to reject it outright. If a user sees a residual value that is relatively low, they can select that value in the residual interface 712, which causes the model fit interface 710, reference compound interface 708, and sample compound interface 706 to update as described above in connection with selecting a model point. The user can then rematch or unmatch a reference peak in order to improve the residual value, or have the peak excluded from contributing to the model fit. This procedure allows a user to exclude points that cannot be fitted as precisely by the model, even if that information would not be easily discernible in the model fit interface 710.

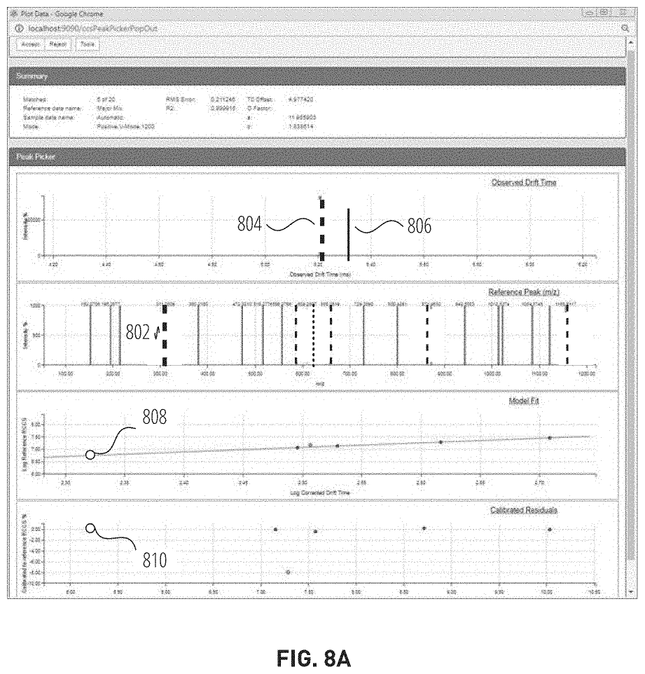

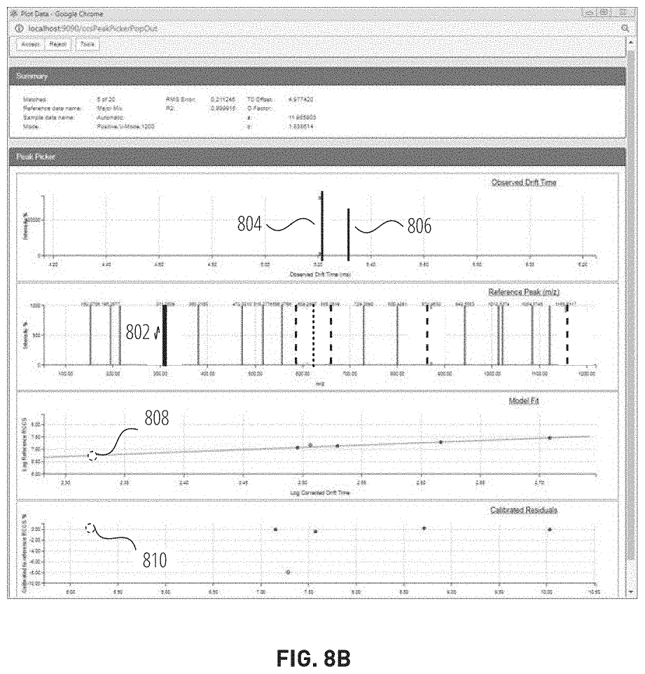

FIG. 8A and FIG. 8B depict an example of unmatching a matched reference peak. In this example a selection of a selected reference peak 802 is received in the reference compound interface. As in the previous examples, the selected reference peak 802 is shown with a dashed line because it has been matched to a sample peak. It is also shown in bold because it has been selected. In response, the sample compound interface is updated to display the available sample peaks that were within a window around the reference peak; the lengths of the lines for each of the peaks may correspond to their intensity as measured by the detector. In this case, two sample peaks were available: a more intense matched sample peak 804 that the automated calibration algorithm selected to match to the selected reference peak 802, and a less intense alternate sample peak 806 that was not selected. Because the matched sample peak 804 was matched to the selected reference peak 802, it is shown in dashed lines and bolded. The alternate sample peak 806 is shown as a solid, unbolded line to show that it was not matched. FIG. 8A also shows how the model fit interface is updated to show a model point 808 corresponding to the selected reference peak 802 in bold, and how the residual interface is updated to show a residual value 810 corresponding to the selected reference peak 802 in bold.

If a user decides to reject the match between the selected reference peak 802 and the matched sample peak 804, the user can simply click in the sample compound interface away from any of the sample peaks in order to deselect all sample peaks. With the sample peaks deselected, the various interfaces are updated as shown in FIG. 8B. In particular, the matched sample peak 804 in the sample compound interface is changed to be unbolded and a solid line, to reflect that it is neither matched nor selected. The selected reference peak 802 in the reference compound interface is changed to a solid bolded line to reflect that it is still selected (bold) but no longer matched (solid). The model point 808 and residual value 810 are changed to dashed lines or different colors to reflect that this point no longer contributes to the model.

As an alternative, the user could have decided to remap the selected reference peak 802 to the alternate sample peak 806 by selecting the alternate sample peak 806 in the sample compound interface. The interfaces displayed would then be updated to reflect the new match and corresponding updated model fit: the alternate sample peak 806 would show as bolded and dashed, the selected reference peak 802 would remain bolded and dashed, and the model point 808 and residual value 810 would be updated with new values based on the updated calibration adjustment calculated from the updated model.

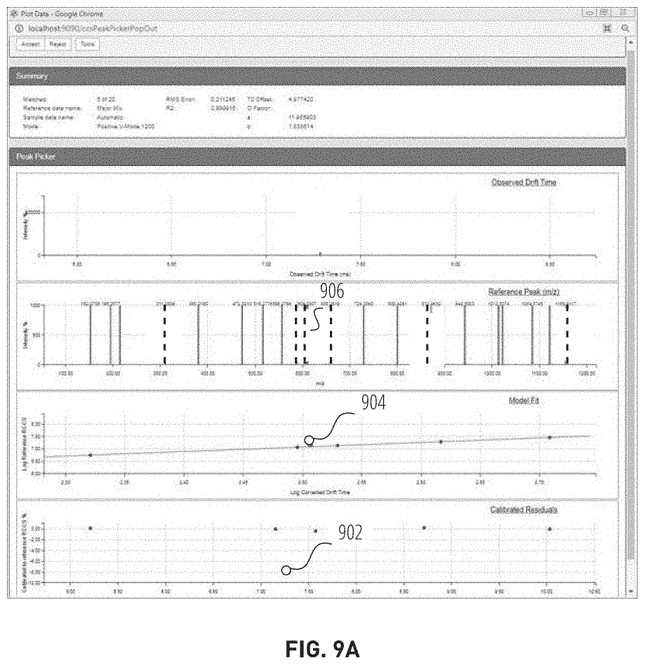

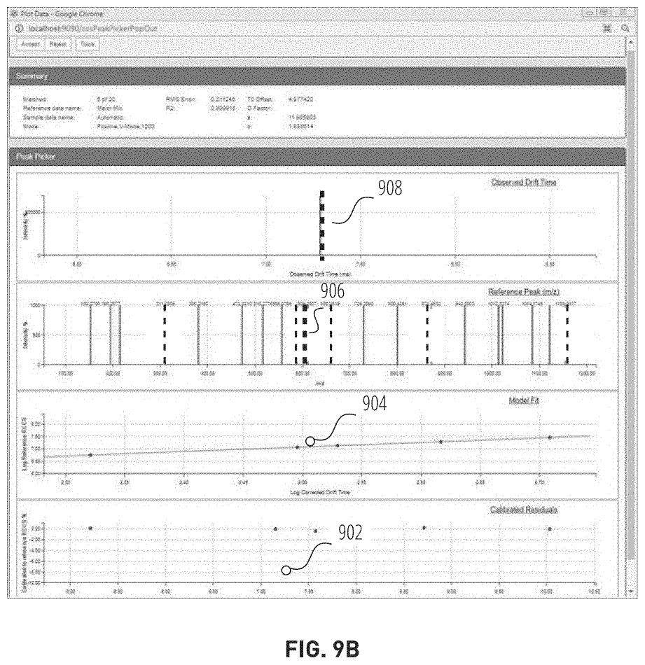

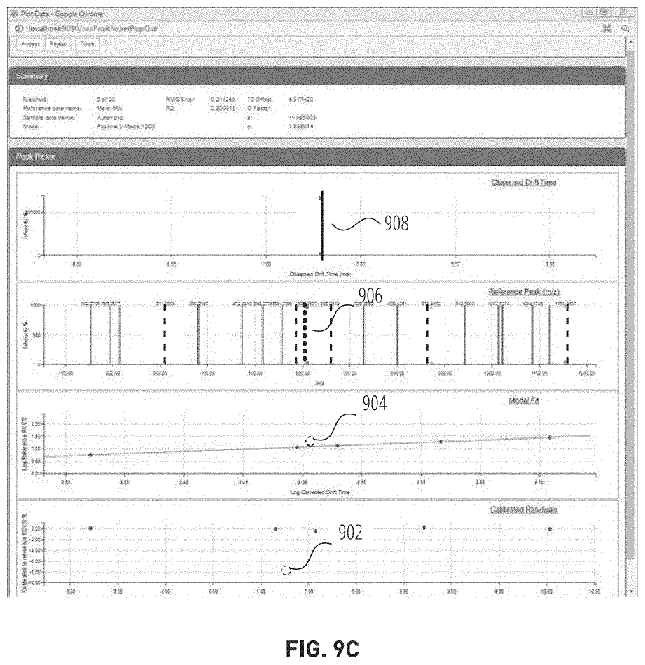

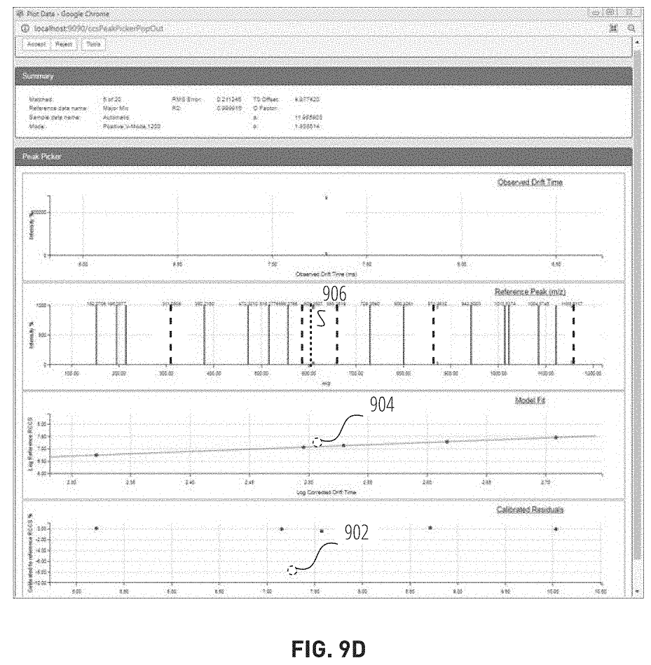

FIG. 9A-FIG. 9D depict exemplary interfaces in which a user interacts with the model fit interface 710 or the residual interface 712. This example will be described as though a user selects a point in the model fit interface 710, although it is understood that corresponding actions would be taken if a residual point were selected in the residual interface 712; because the discussion would be repetitive, a specific example of selecting a point in the residual interface 712 is omitted here.

FIG. 9A depicts the various interfaces before any points or peaks are selected. In this example, a reference peak 906 has been matched (as signified by the dashed line), but because it is not currently selected, no peaks appear in the sample compound interface. The reference peak 906 has a corresponding model point 904 in the model fit interface, and a corresponding residual value 902.

If the user selects the model point 904, the residual value 902 and the reference peak 906 become selected and bolded. Because the reference peak 906 is now selected, the sample compound interface is updated to display any of the sample peaks within the window of the reference peak 906. This includes the corresponding sample peak 908 to which the reference peak 906 has been mapped. Both the reference peak 906 and corresponding sample peak 908 are bolded and shown in dashed lines, to indicate that they have been matched.

If the user then opts to reject the match (e.g., by clicking in the sample compound interface in an area away from the corresponding sample peak 908), then the corresponding sample peak 908 may become unmatched from the reference peak 906. This is shown in FIG. 9C, where the corresponding sample peak 908 has been updated to show that it is no longer matched to the reference peak 906. Accordingly, the corresponding sample peak 908 is now shown as an unbolded solid line, while the reference peak 906 is now shown as a dotted line. Because these peaks are no longer contributing to the model, the model point 904 and residual value 902 are shown as dashed lines.

The corresponding sample peak 908 may continue to be shown in the sample compound interface as long as the reference peak 906 is selected, because the corresponding sample peak 908 is still within the window of the reference peak 906. As the user clicks away from the reference and sample compound interfaces, these interfaces are updated to reflect that no peaks are selected; the reference peak 906 is unbolded since it is no longer selected, and the sample compound interface is emptied since no reference peak is selected.

For the sake of clarity, it is noted that dashed lines in the Figures may refer to different things depending on the context. For instance, when a peak is shown in dashed lines in the sample compound interface or the reference compound interface, this indicates that it has been matched to a corresponding peak in the other data set; a solid line indicates no match. On the other hand, when a point is shown in solid line in the model fit interface or the residual interface, this indicates that the point is not contributing to the model and therefore the calibrating adjustment; a solid line around the point indicates that the point is contributing.

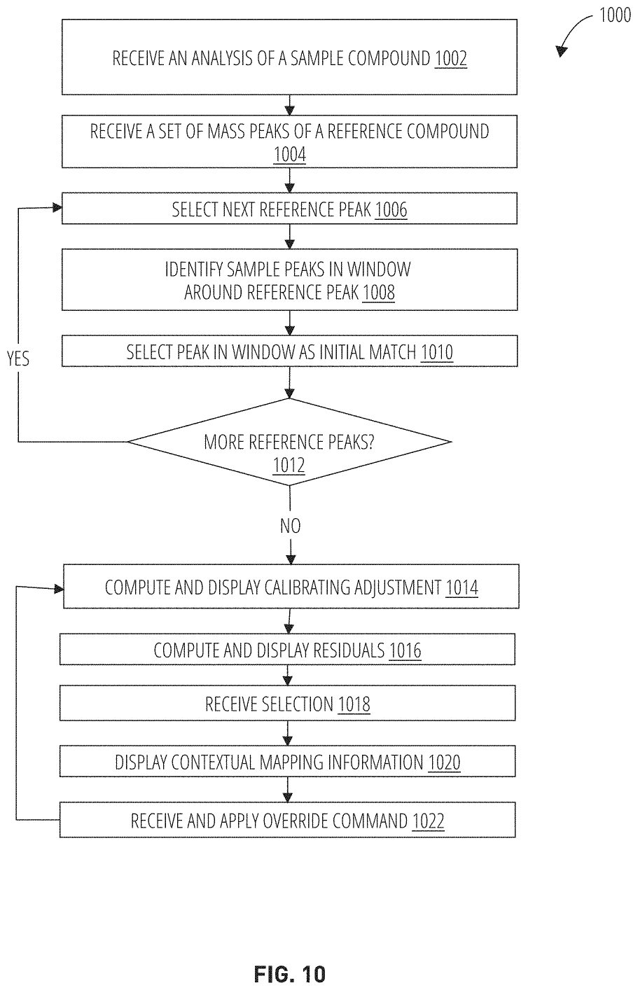

FIG. 10 depicts exemplary logic 1000 that can be used to perform the embodiments described herein. The logic 1000 may be embodied as a method performed by a processor of a computing device having a display. Alternatively or in addition, the logic 1000 may be embodied as instructions stored on a non-transitory computer-readable medium that are executable by a processor to perform the embodiments described herein. Still further, the logic 1000 may be encoded into an apparatus, such as a computing device having a memory and a processor.

The logic 1000 begins at block 1002, where an analysis of a sample compound is received. The sample compound may correspond to a specified reference compound used to calibrate a mass spectrometry device. The analysis of the sample compound may be received directly from the mass spectrometry device or may be provided in the form of a file including sample data. The analysis of the sample compound may include a set of intensity values indicating the intensity of a signal received by a detector, and a corresponding drift time at which the signal was received.

At block 1004, a set of mass peaks of a reference compound may be received. The set of mass peaks may be a list of predefined expected mass-to-charge ratios for molecules of the reference compound and may be retrieved from a predefined library of reference compounds. Alternatively or in addition, a user may provide a file including the mass-to-charge ratios.

Next, the reference peaks may be mapped to the sample peaks. Each of the molecules of the sample compound will have a mass-to-charge ratio that affects its drift time through the IMS device; block 1006 through block 1012 attempt to match the observed drift times to corresponding mass peaks in the reference data.

At block 1006, the next reference peak for analysis may be selected. If no previous peaks have been analyzed, the first reference peak in the data may be selected as an initial match candidate. At block 1008, an expected drift time corresponding to the mass-to-charge ratio of the selected reference peak may be determined and a window around the expected drift time may be determined. One of ordinary skill in the art will understand how to select an appropriate drift time and window. Within this window in the sample data, any peaks above a predetermined minimum threshold value may be selected for comparison.

Each peak in the window may be associated with an intensity value. In this initial pass through the sample data, the peak with the highest intensity within the window may be selected as an initial match at block 1010. If no corresponding sample peaks are found within the window, then the reference peak may remain unmatched. Furthermore, after the residuals are computed at block 1016, the system may optionally reject any match having a residual value below a predetermined threshold, causing the peak to become unmatched.

At block 1012, it is determined whether more reference peaks remain to be matched. If so, processing returns to block 1006; if not, processing proceeds to block 1014.

At block 1014, a calibrating adjustment may be computed and displayed. This may involve defining a model or function that maps the sample compound peaks to their expected drift times or m/z ratios as determined by the reference data. The model or function may have adjustable parameters that scale the sample data in different ways, and these parameters may be adjusted until a stopping condition is met or a best fit is found. The model or function may represent a calibrating adjustment that can be applied to future data from the MS device to harmonize the data with other data from different devices or acquired at different times. The model fit may be represented on the display as a regression line passing through model points corresponding to the reference peaks used to compute the model.

At block 1016, the model fit may be used to compute a residual value, representing how well the model causes the mapped reference/sample peaks to match each other. The residuals may be displayed as residual points in an interface.

At block 1018, a selection may be received in an interface from a user. They user may select, for example, a reference peak in the reference compound interface, a model point in the model fit interface, or a residual value in the residual interface. Upon receiving the selection, at block 1020 contextual mapping information may be displayed in the interface. If the selection was a selection of a reference peak, then the sample peaks within the reference peak's window may be displayed in the sample compound interface, and the model point and residual value corresponding to the selected reference peak may be highlighted in their corresponding interfaces. If a model point or residual value is selected, the other interfaces may be updated in a similar manner based on the data values that correspond to the selected point/value. Optionally, the peaks in the sample compound interface that are within a window corresponding to a reference peak may be displayed immediately upon receiving a selection of a model point or residual value associated with the reference peak. As an alternatively, only the reference peak may be highlighted, and the system may refrain from updating the sample compound interface with the sample peaks within the window until the user affirmatively selects the highlighted reference peak.

At block 1022, the system may receive an override command. This command may involve causing the reference peak to be unmatched from any of the sample peaks in the window, matching the reference peak to a different sample peak within the window, or requesting that a model point or residual value be set so as to not contribute to the model. In these latter two cases, such an override command might simply cause the reference peak associated with the selected point/value to become unmatched.

Processing may then return to block 1014 and repeat in this manner until the user is satisfied with their calibrating adjustment as shown by the model fit. When the user is satisfied, they can save the calibrating adjustment for future use, and it can be applied to future (or past) data received from the MS apparatus.

FIG. 11 illustrates one example of a system architecture and data processing device that may be used to implement one or more illustrative aspects described herein in a standalone and/or networked environment. Various network nodes, such as the data server 1110, web server 1106, computer 1104, and laptop 1102 may be interconnected via a wide area network 1108 (WAN), such as the internet. Other networks may also or alternatively be used, including private intranets, corporate networks, LANs, metropolitan area networks (MANs) wireless networks, personal networks (PANs), and the like. Network 1108 is for illustration purposes and may be replaced with fewer or additional computer networks. A local area network (LAN) may have one or more of any known LAN topology and may use one or more of a variety of different protocols, such as ethernet. Devices data server 1110, web server 1106, computer 1104, laptop 1102 and other devices (not shown) may be connected to one or more of the networks via twisted pair wires, coaxial cable, fiber optics, radio waves or other communication media.

Computer software, hardware, and networks may be utilized in a variety of different system environments, including standalone, networked, remote-access (aka, remote desktop), virtualized, and/or cloud-based environments, among others.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 1110, web server 1106, and client computer 1104, laptop 1102. Data server 1110 provides overall access, control and administration of databases and control software for performing one or more illustrative aspects described herein. Data server 1110 may be connected to web server 1106 through which users interact with and obtain data as requested. Alternatively, data server 1110 may act as a web server itself and be directly connected to the internet. Data server 1110 may be connected to web server 1106 through the network 1108 (e.g., the internet), via direct or indirect connection, or via some other network. Users may interact with the data server 1110 using remote computer 1104, laptop 1102, e.g., using a web browser to connect to the data server 1110 via one or more externally exposed web sites hosted by web server 1106. Client computer 1104, laptop 1102 may be used in concert with data server 1110 to access data stored therein or may be used for other purposes. For example, from client computer 1104, a user may access web server 1106 using an internet browser, as is known in the art, or by executing a software application that communicates with web server 1106 and/or data server 1110 over a computer network (such as the internet).

Servers and applications may be combined on the same physical machines, and retain separate virtual or logical addresses, or may reside on separate physical machines. FIG. 11 illustrates just one example of a network architecture that may be used, and those of skill in the art will appreciate that the specific network architecture and data processing devices used may vary, and are secondary to the functionality that they provide, as further described herein. For example, services provided by web server 1106 and data server 1110 may be combined on a single server.

Each component data server 1110, web server 1106, computer 1104, laptop 1102 may be any type of known computer, server, or data processing device. Data server 1110, e.g., may include a processor 1112 controlling overall operation of the data server 1110. Data server 1110 may further include RAM 1116, ROM 1118, network interface 1114, input/output interfaces 1120 (e.g., keyboard, mouse, display, printer, etc.), and memory 1122. Input/output interfaces 1120 may include a variety of interface units and drives for reading, writing, displaying, and/or printing data or files. Memory 1122 may further store operating system software 1124 for controlling overall operation of the data server 1110, control logic 1126 for instructing data server 1110 to perform aspects described herein, and other application software 1128 providing secondary, support, and/or other functionality which may or may not be used in conjunction with aspects described herein. The control logic may also be referred to herein as the data server software control logic 1126. Functionality of the data server software may refer to operations or decisions made automatically based on rules coded into the control logic, made manually by a user providing input into the system, and/or a combination of automatic processing based on user input (e.g., queries, data updates, etc.).

Memory 1122 may also store data used in performance of one or more aspects described herein, including a first database 1132 and a second database 1130. In some embodiments, the first database may include the second database (e.g., as a separate table, report, etc.). That is, the information can be stored in a single database, or separated into different logical, virtual, or physical databases, depending on system design. Web server 1106, computer 1104, laptop 1102 may have similar or different architecture as described with respect to data server 1110. Those of skill in the art will appreciate that the functionality of data server 1110 (or web server 1106, computer 1104, laptop 1102) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A method comprising:
receiving an analysis of a sample compound from a mass spectrometry (MS) apparatus, the analysis associated with a plurality of mass peaks;
receiving a set of mass peaks of a reference compound;
mapping a subset of the plurality of mass peaks of the sample compound to a corresponding subset of peaks of the reference compound, the mapping matching a first peak of the reference compound to a first peak of the sample compound;
overriding the mapping by performing at least one of:
matching the first peak of the reference compound to a second peak of the sample compound, or
matching the first peak of the reference compound to no peak in the sample compound; and
using the mapping to define a calibrating adjustment.

2. The method of claim 1, wherein the MS apparatus is an ion mobility mass spectrometry apparatus.

3. The method of claim 1, wherein the reference compound is a custom reference compound received from a user.

4. The method of claim 1, further comprising:
displaying the corresponding subset of peaks of the reference compound in a reference compound interface on a display;
receiving a selection of the first peak of the reference compound; and
displaying, in a sample compound interface on the display, a plurality of peaks of the sample compound that fall within a predefined window of masses around the first peak of the reference compound, the plurality of peaks comprising the first peak of the sample compound and the second peak of the sample compound.

5. The method of claim 4, wherein overriding the mapping comprises receiving a selection of the second peak of the sample compound in the sample compound interface.

6. The method of claim 1, further comprising:
for each of the plurality of mass peaks of the sample compound mapped to corresponding peaks of the reference compound, calculating a residual value based on how a closeness of a match between each mapped pair of peaks;
displaying the residual values in a residual interface on the display;
receiving a selection of one of the residual values, the selected residual value corresponding to a pair of matched peaks from the reference compound and the sample compound;
removing the mapping between the pair of matched peaks; and
recalculating the calibrating adjustment.

7. The method of claim 1, wherein the calibrating adjustment is based on a plurality of points fitted with a regression line, and further comprising:
displaying the plurality of points and the regression line in a model fit interface on the display;
receiving a selection of one of the points, the selected point corresponding to a pair of matched peaks from the reference compound and the sample compound;
removing the mapping between the pair of matched peaks; and
recalculating the calibrating adjustment with the selected point removed from the plurality of points.

8. A non-transitory computer-readable storage medium, the computer-readable storage medium including instructions that when executed by a computer, cause the computer to:
receive an analysis of a sample compound from a mass spectrometry (MS) apparatus, the analysis associated with a plurality of mass peaks;
receive a set of mass peaks of a reference compound;
map a subset of the plurality of mass peaks of the sample compound to a corresponding subset of peaks of the reference compound, the mapping matching a first peak of the reference compound to a first peak of the sample compound;
override the mapping by performing at least one of:
match the first peak of the reference compound to a second peak of the sample compound, or
match the first peak of the reference compound to no peak in the sample compound; and
use the mapping to define a calibrating adjustment.

9. The computer-readable storage medium of claim 8, wherein the MS apparatus is an ion mobility mass spectrometry apparatus.

10. The computer-readable storage medium of claim 8, wherein the reference compound is a custom reference compound received from a user.

11. The computer-readable storage medium of claim 8, wherein the instructions further configure the computer to:
display the corresponding subset of peaks of the reference compound in a reference compound interface on a display;
receive a selection of the first peak of the reference compound; and
display, in a sample compound interface on the display, a plurality of peaks of the sample compound that fall within a predefined window of masses around the first peak of the reference compound, the plurality of peaks comprising the first peak of the sample compound and the second peak of the sample compound.

12. The computer-readable storage medium of claim 11, wherein overriding the mapping comprises receive a selection of the second peak of the sample compound in the sample compound interface.

13. The computer-readable storage medium of claim 8, wherein the instructions further configure the computer to:
for each of the plurality of mass peaks of the sample compound mapped to corresponding peaks of the reference compound, calculate a residual value based on how a closeness of a match between each mapped pair of peaks;
display the residual values in a residual interface on the display;
receive a selection of one of the residual values, the selected residual value corresponding to a pair of matched peaks from the reference compound and the sample compound;
remove the mapping between the pair of matched peaks; and
recalculate the calibrating adjustment.

14. The computer-readable storage medium of claim 8, wherein the calibrating adjustment is based on a plurality of points fitted with a regression line, and wherein the instructions further configure the computer to:
display the plurality of points and the regression line in a model fit interface on the display;
receive a selection of one of the points, the selected point corresponding to a pair of matched peaks from the reference compound and the sample compound;
remove the mapping between the pair of matched peaks; and
recalculate the calibrating adjustment with the selected point removed from the plurality of points.

15. A computing apparatus comprising:
a processor; and
a memory storing instructions that, when executed by the processor, configure the apparatus to:
receive an analysis of a sample compound from a mass spectrometry (MS) apparatus, the analysis associated with a plurality of mass peaks;
receive a set of mass peaks of a reference compound;
map a subset of the plurality of mass peaks of the sample compound to a corresponding subset of peaks of the reference compound, the mapping matching a first peak of the reference compound to a first peak of the sample compound;
override the mapping by performing at least one of:
match the first peak of the reference compound to a second peak of the sample compound, or
match the first peak of the reference compound to no peak in the sample compound; and
use the mapping to define a calibrating adjustment.

16. The computing apparatus of claim 15, wherein the MS apparatus is an ion mobility mass spectrometry apparatus.

17. The computing apparatus of claim 15, wherein the instructions further configure the apparatus to:
display the corresponding subset of peaks of the reference compound in a reference compound interface on a display;
receive a selection of the first peak of the reference compound; and
display, in a sample compound interface on the display, a plurality of peaks of the sample compound that fall within a predefined window of masses around the first peak of the reference compound, the plurality of peaks comprising the first peak of the sample compound and the second peak of the sample compound.

18. The computing apparatus of claim 17, wherein overriding the mapping comprises receive a selection of the second peak of the sample compound in the sample compound interface.

19. The computing apparatus of claim 15, wherein the instructions further configure the apparatus to:
for each of the plurality of mass peaks of the sample compound mapped to corresponding peaks of the reference compound, calculate a residual value based on how a closeness of a match between each mapped pair of peaks;
display the residual values in a residual interface on the display;
receive a selection of one of the residual values, the selected residual value corresponding to a pair of matched peaks from the reference compound and the sample compound;
remove the mapping between the pair of matched peaks; and
recalculate the calibrating adjustment.

20. The computing apparatus of claim 15, wherein the calibrating adjustment is based on a plurality of points fitted with a regression line, and wherein the instructions further configure the apparatus to:
display the plurality of points and the regression line in a model fit interface on the display;
receive a selection of one of the points, the selected point corresponding to a pair of matched peaks from the reference compound and the sample compound;
remove the mapping between the pair of matched peaks; and
recalculate the calibrating adjustment with the selected point removed from the plurality of points.
